(19) United States
(12) Patent Application Publication
(10) Pub. No.: US 2005/0036522 A1
(43) Pub. Date: Feb. 17, 2005

(54) Multiplexers in a synchronous optical network

(75) Inventors: Donald J. Glaser, Huntington Beach, CA (US); Carl E. Gabrielson JR., Santa Ana, CA (US); Dale M. Terrien, Yorba Linda, CA (US)

Correspondence Address: FOGG AND ASSOCIATES, LLC, P.O. BOX 581339, MINNEAPOLIS, MN, 55458-1339, US

(73) Assignee: ADC DSL Systems, Inc.

(21) Appl. No.: 10/641,910

(22) Filed: Aug. 15, 2003

(51) Int. Cl. H04J 3/04

(52) U.S. Cl. 370/535; 370/907

(57) ABSTRACT

Described is a reconfigurable multiplexer that can multiplex different combinations of channel types. For instance, the multiplexer can be configured to multiplex 28 DS-1 channels and two STS-1 channels into an OC-3 channel. Alternatively, the same multiplexer can be reconfigured to multiplex 28 DS-1 channels into an STS-1 channel.

### TECHNICAL FIELD

The present invention generally relates SONET multiplexers and more particularly to reconfigurable SONET multiplexers.

### BACKGROUND

A typical SONET multiplexer card is configured to multiplex/demultiplex some channel types, which cannot be changed after configuration. In other words, the input and output ports of the typical multiplexer card are dedicated. For example, the SONET multiplexer card can be configured to multiplex 28 DS-1 channels (each having a channel rate of 1.544 Megabits per second, i.e., Mbps) and two STS-1 channels (51.84 Mbps each) into an OC-3 channel (155.52 Mbps). However, once so configured, the SONET multiplexer card cannot be reconfigured to multiplex another combination of channel types. In other words, in order to multiplex 28 DS-1 channels and two DS-3 channels (instead of two STS-1 channels as mentioned above) into an OC-3 channel, another SONET multiplexer card configured accordingly must be used.

Accordingly, there is a need for a SONET multiplexer that can multiplex different combinations of channel types.

### SUMMARY

In one embodiment, a system for mapping channel types is described. The system comprises a controller and a mapper coupled to the controller, wherein the mapper is reconfigurable by the controller to map at least a first combination and a second combination of channel types.

In another embodiment, a SONET multiplexer for multiplexing channel types is described. The multiplexer comprises a controller, a mapper coupled to the controller, and a configuration data interface coupled to the controller, wherein the configuration data interface is designed to receive configuration data to be used by the controller to configure the mapper so that the multiplexer can multiplex more than one combination of channel types.

### DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a SONET multiplexer 100 according to one embodiment of the present invention.

### DETAILED DESCRIPTION

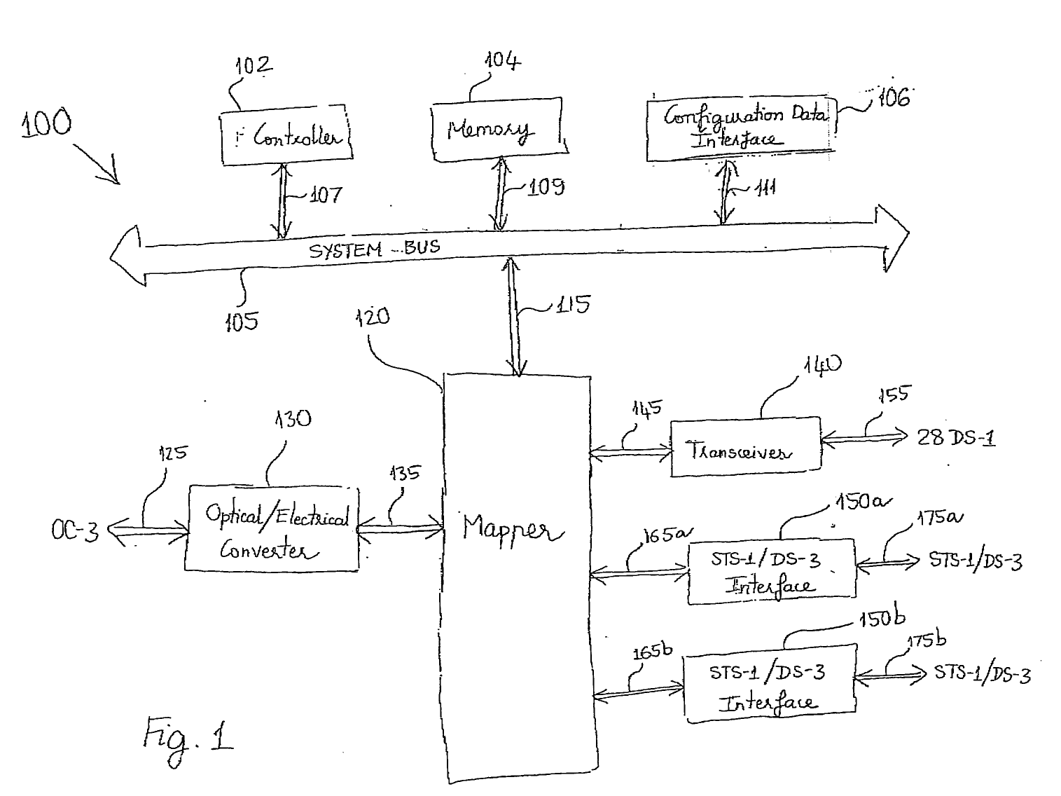

FIG. 1 is a SONET multiplexer 100 according to one embodiment of the present invention. Illustratively, the SONET multiplexer 100 comprises a system bus 105, a controller 102, a memory 104, a configuration data interface 106, a mapper 120, an optical/electrical converter 130, a transceiver 140, and two STS-1/DS-3 interface circuits 150a & 150b.

The controller 102, the memory 104, the configuration data interface 106, and the mapper 120 are coupled to the system bus 105 via the connections 107, 109, 111, and 115, respectively. The mapper 120 is also coupled to the optical/electrical converter 130, the transceiver 140, and the STS-1/DS-3 interface circuits 150a & 150b via connections 135, 145, 165a, and 165b, respectively.

In one embodiment, the STS-1/DS-3 interface circuits 150a & 150b, by examining an in-coming bitstream, can recognize whether the in-coming bitstream, in either upstream or downstream direction, is an STS-1 or a DS-3 bitstream and operate accordingly. In one embodiment, each of the STS-1/DS-3 interface circuits 150a & 150b receives the coming digital bitstream and prepares it without changing the digital data, and passes it on to the receiver at the other end of the connection so that the receiver can recognize the bitstream. For instance, the bitstream entering the multiplexer 100 on the connection 175a may be weak and the waveform is not square. In another embodiment, the STS-1/DS-3 interface circuits 150a & 150b are configured by the controller 102.

In one embodiment, each of the connections in FIG. 1 can be bi-directional (i.e., carrying bitstreams in both directions), can comprise one or more conducting wires, can be wireless or optical fibers, and can be of any type that can carry digital signals.

For illustration of the operation of the SONET multiplexer 100, assume that the multiplexer 100 is initially configured to multiplex 28 DS-1 channels and two STS-1 channels into an OC-3 channel. More specifically, configuration data is loaded into the multiplexer 100 via the configuration data interface 106 and stored in the memory 104 via the system bus 105. The controller 102 uses the loaded configuration data in the memory 104 to configure the mapper 120 to map the 28 DS-1 channels and the two STS-1 channels on the connections 145, 165a, and 165b, respectively into the STS-3 channel on the connection 135 in the upstream direction. The STS-3 channel on the connection 135 is converted by the optical/electrical converter 130 to the OC-3 channel on the connection 125. These channels are bi-directional. This means that in the downstream direction, the mapper 120 also maps the STS-3 channel on the connection 135 into the 28 DS-1 channels and the two STS-1 channels on the connections 145, 165a, and 165b, respectively.

More specifically, in the upstream direction, 28 DS-1 bitstreams enters the multiplexer 100 on the connection 155 and flows through the transceiver 140 to the mapper 120 via the connection 145. A first STS-1 bitstream enters the multiplexer 100 on the connection 175a and flows through the STS-1/DS-3 interface circuit 150a to the mapper 120 via the connection 165a. Similarly, a second STS-1 bitstream enters the multiplexer 100 on the connection 175b and flows through the STS-1/DS-3 interface circuit 150b to the mapper 120 via the connection 165b.

The bitstreams on the connections 165a, and 165bflow upstream to the mapper 120 and are time-multiplexed by the mapper 120 into an STS-3 bitstream to be sent upstream on the connection 135 to the optical/electrical converter 130. The STS-3 bitstream is converted into an optical OC-3 bitstream and sent upstream on the connection 125 out of the multiplexer 100. In other words, the optical/electrical converter 130 interfaces the OC-3 channel on the connection 125 with the STS-3 channel on the connection 135 from the mapper 120.

In the downstream direction, an OC-3 bitstream enters the multiplexer 100 on the connection 125 and flows to the optical/electrical converter 130. Here, the optical OC-3 bitstream is converted by the optical/electrical converter 130 into an electrical STS-3 bitstream to be sent on the connection 135 to the mapper 120. The mapper 120 maps the STS-3 bitstream on the connection 135 into 28 DS-1 bitstreams and two STS-1 bitstreams to be sent downstream on the connection 145, 165a, and 165b, respectively.

In one embodiment, the 28 DS-1 bitstreams on the connection 145 flow through the transceiver 140. Here, the 28 DS-1 bitstreams are buffered and sent downstream out of the multiplexer 100 on the connection 155. The STS-1bitstream on the connection 165aenters the STS-1/DS-3 interface circuits 150a where the STS-1 bitstream is repeated and sent downstream out of the multiplexer 100 on the connection 175a. Similarly, the STS-1 bitstream on the connection 165b enters the STS-1/DS-3 interface circuits 150b where the STS-1 bitstream is repeated and sent downstream out of the multiplexer 100 on the connection 175b.

Assume now that the multiplexer 100 is re-configured to multiplex 28 DS-1 channels and two DS-3 channels (instead of two STS-1 channels as before) into an OC-3 channel. More specifically, other configuration data is loaded into the multiplexer 100 via the configuration data interface 106 and stored in the memory 104. The controller 102 uses the loaded configuration data in the memory 104 to configure the mapper 120 to map the 28 DS-1 channels and the two DS-3 channels on the connections 145, 165a, and 165b, respectively into the STS-3 channel on the connection 135 in the upstream direction. The STS-3 channel on the connection 135 is converted by the optical/electrical converter 130 to the OC-3 channel on the connection 125. In the downstream direction, the mapper 120 also maps the STS-3 channel on the connection 135 into the 28 DS-1 channels and the two DS-3 channels on the connections 145, 165a, and 165b, respectively.

The detailed operation of the multiplexer 100 after reconfiguration is similar to that of the multiplexer 100 before reconfiguration except that the multiplexer 100 now receives two DS-3 bitstreams, instead of two STS-1 bitstreams, on the connections 175a and 175b. Also, the multiplexer 100 sends downstream two DS-3 bitstreams, instead of two STS-1 bitstreams, on the connection 175a and 175b.

In summary, the multiplexer 100 is reconfigurable to multiplex different combinations of channel types. The multiplexer 100 can receive configuration data via the configuration data interface 106 and stores the configuration data in the memory 104. Then, the controller 102 can use the configuration data to configure the mapper 120 to map one of the different combinations of channel types. The STS-1/DS-3 interface circuits 150a and 150b are capable of handling both STS-1 and DS-3 bitstreams. This increases the number of combinations of channel types the multiplexer 100 can handle. In one embodiment, for each combination of channel types, the total bandwidth of the bitstream or bitstreams entering the mapper 120 must substantially equal the total bandwidth of the bitstream or bitstreams leaving the mapper 120. The difference, if any, is due to different overheads in the bitstreams.

For instance, in one combination of channel types, the multiplexer 100 can multiplex 28 DS-1 channels, one STS-1 channel, and one DS-1 channel on the connections 155, 175a, and 175b, respectively, into an OC-3 channel on the connection 125. In another combination of channel types, the multiplexer 100 can multiplex 28 DS-1 channels on the connection 155 into one STS-1 channel on the connection 175a in the upstream direction. In this case, the STS-1/DS-3 interface circuit 150a is used. The STS-1/DS-3 interface circuit 150b and the optical/electrical converter 130 are not used. It should be noted in FIG. 1 that flowing from the mapper 120 to the right does not necessarily mean flowing downstream. In general, the flowing direction (to the left or right) of a bitstream in FIG. 1 does not tell whether the bitstream is flowing upstream or down stream.

The present invention is not limited to the embodiments described above. In an alternative embodiment, the STS-1/DS-3 interface circuits 150a & 150b need to be configured by the controller 102 before the STS-1/DS-3 interface circuits 150a & 150b can handle either an STS-1 or a DS-3 bitstream. For example, in order for an STS-1/DS-3 interface circuit 150 to work with an STS-1 bitstream, it must first be configured by the controller 120 to do so.

In one embodiment, all configuration data for all possible configurations are loaded into the memory 104 only once. Alternatively, the memory 104 can be a ROM (Read-Only Memory) and all the configuration data for all possible configurations can be stored in the ROM memory 104.

In one embodiment, the mapper 120 can be an ULTRAMAPPER TMXL84622 OC-3 mapper from Agere Systems, Inc and the controller 102 can be an MPC860T microprocessor from Motorola, Inc.

While the foregoing is directed to embodiments of the present invention, other and further embodiments of the invention may be devised without departing from the basic scope thereof, and the scope thereof is determined by the claims that follow.

1. A system, comprising:
a controller;
a mapper coupled to the controller, wherein the mapper is reconfigurable by the controller to map at least a first combination and a second combination of channel types.

2. The system of claim 1, further comprising an optical/electrical converter coupled to the mapper, wherein the optical/electrical converter is configured to interface an optical channel to an electrical channel from the mapper.

3. The system of claim 1, further comprising at least an STS-1/DS-3 interface circuit coupled to the mapper, wherein the STS-1/DS-3 interface circuit is capable of working with both STS-1 and DS-3 bitstreams.

4. The system of claim 1, further comprising a memory coupled to the controller, wherein the memory is capable of storing configuration data to be used by the controller to configure the mapper to map the first and second combinations of channel types.

5. The system of claim 4, further comprising a configuration data interface coupled to the controller, wherein the configuration data interface is configured to receive configuration data to be used by the controller to configure the mapper to handle the first and second combinations of channel types.

6. The system of claim 5, wherein the first combination of channel types comprises an STS-3 channel, 28 DS-1 channels, and two STS-1 channels, wherein the mapper maps the 28 DS-1 channels and two STS-1 channels into the STS-3 channel.

7. The system of claim 6, wherein the mapper is a TMXL86422.

8. The system of claim 1, further comprising a configuration data interface coupled to the controller, wherein the configuration data interface is configured to receive configuration data to be used by the controller to configure the mapper to handle the first and second combinations of channel types.

9. The system of claim 8, wherein the first combination of channel types comprises an STS-3 channel, 28 DS-1 channels, and two DS-3 channels, wherein the mapper maps the 28 DS-1 channels and two DS-3 channels into the STS-3 channel.

10. The system of claim 9, wherein the mapper is a TMXL86422.

11. A multiplexer, reconfigurable to multiplex at least a first combination and a second combination of channel types.

12. The multiplexer of claim 11, further comprising:
a mapper;
a controller coupled to the mapper; and
an optical/electrical converter coupled to the mapper, wherein
the mapper is reconfigurable by the controller so that the multiplexer is capable of multiplexing at least the first and second combinations of channel types,
the first combination of channel types comprises an optical channel, and
the optical/electrical converter interfaces the optical channel to an electrical channel from the mapper.

13. The multiplexer of claim 12, further comprising at least an STS-1/DS-3 interface circuit coupled to the mapper, wherein the STS-1/DS-3 interface circuit is capable of working with both STS-1 and DS-3 bitstreams.

14. The multiplexer of claim 13, further comprising a memory coupled to the controller, wherein the memory is capable of storing configuration data to be used by the controller to configure the mapper so that the multiplexer can multiplex at least the first and second combinations of channel types.

15. The multiplexer of claim 14, further comprising a configuration data interface coupled to the controller, wherein the configuration data interface is configured to receive configuration data to be used by the controller to configure the mapper so that the multiplexer can multiplex at least the first and second combinations of channel types.

16. The multiplexer of claim 15, wherein the first combination of channel types comprises an OC-3 channel, 28 DS-1 channels, and two STS-1 channels, wherein the multiplexer multiplexes the 28 DS-1 channels and two STS-1channels into the OC-3 channel.

17. The multiplexer of claim 16, wherein the mapper is a TMXL86422.

18. The multiplexer of claim 11, further comprising a memory coupled to the controller, wherein the memory is capable of storing configuration data to be used by the controller to configure the mapper so that the multiplexer can multiplex at least the first and second combinations of channel types.

19. The multiplexer of claim 18, further comprising a configuration data interface coupled to the controller, wherein the configuration data interface is configured to receive configuration data to be used by the controller to configure the mapper so that the multiplexer can multiplex at least the first and second combinations of channel types.

20. A SONET multiplexer, comprising:
a controller;
a mapper coupled to the controller; and
a configuration data interface coupled to the controller; wherein the configuration data interface is designed to receive configuration data to be used by the controller to configure the mapper so that the multiplexer can multiplex more than one combination of channel types.
